(19) United States
(12) Patent Application Publication
(10) Pub. No.: US 2011/0193479 A1
(43) Pub. Date: Aug. 11, 2011

(54) Evaporation Cooled Lamp

(76) Inventors: Ole K. Nilssen, Bonita Springs, FL (US); Dale Fiene, Algonquin, IL (US)

(21) Appl. No.: 13/020,909

(22) Filed: Feb. 4, 2011

Related U.S. Application Data
(60) Provisional application No. 61/302,373, filed on Feb. 8, 2010.

(51) Int. Cl. H01J 13/46; H01J 61/52; H01K 1/62

(52) U.S. Cl. 315/35; 313/46; 315/32

(57) ABSTRACT

LED or other lamps that remove heat using evaporation of water or other coolant inside a lamp enclosure structure such as a glass bulb typically without the use of external heat sinks or fins. Optionally, the pressure inside the enclosure can be reduced to lower the boiling point of the coolant. One or more LEDs or other light source can be mounted on a support structure that conducts heat to an evaporation surface. A coolant, preferably water or alcohol (or a water/alcohol mixture), is included inside the structure and can be optionally wicked to the evaporation surface. Vaporized coolant condenses on the inside surface of the enclosure or bulb transferring heat to the ambient through the enclosure. The condensed liquid coolant can return to a pool in the bottom of the enclosure.

This application is related to and claims priority from U.S. Provisional Patent application No. 61/302,373 filed Feb. 8, 2010. Application 61/302,373 is hereby incorporated by reference.

### BACKGROUND

1. Field of the Invention

The present invention relates generally to the field of lighting devices and more particularly to lamps that are cooled by the evaporation of water or other coolant inside the lamp.

2. Description of the Prior Art

Light Emitting Diodes (LEDs) are finding a large number of applications in the area of light producing devices where, at one time, only incandescent light bulbs were used. LEDs have several properties that make them desirable such as a very bright output, and a relatively high luminous efficacy in addition to small physical size.

Incandescent light bulbs are being replaced by LED lamps and Compact Fluorescent Lamps (CFLs) because of their notoriously low efficiencies. While CFLs with efficacies of around 55 lumens per Watt are dramatically more efficient than incandescent lamps at around 17 lumens per Watt, LED lamps promise even greater efficacies. LEDs currently on the market have efficacies of over 100 lumens per Watt and are improving every year. Although linear fluorescent lamps can produce 100 lumens per Watt, it is difficult to configure them into small sizes. When a lamp is configured with multiple tubes or a single tube bent in the shape of a coil or spring, as much as half the light generated can be trapped within the coils or between the tubes. The LED, on the other hand, generates nearly all of its light in one hemisphere and can be easily arranged to direct the light outward. Therefore, LED lamps can be constructed that do not have a trapped light issue.

A major problem with LEDs however is the amount of heat they tend to produce. When an LED runs too hot, its effective life is considerably shortened and its efficacy reduced. Thus, heat removal or mitigation becomes a fundamental design issue. The LED needs to be operated at relatively low temperatures to achieve long operating life and good efficacy. As stated, LEDs currently on the market can operate with luminous efficacies of more than 100 Lumens/Watt compared to about 17 Lumens/Watt for a 120 Volt, 100 Watt tungsten light bulb. While LEDs can achieve more than five times the efficiency of an incandescent source, their overall luminous efficiency is still only on the order of 20% with 80% of the input power generating heat. Unlike an incandescent lamp, which needs high temperatures on the order of 4000° F. to operate, the light output and the life of LEDs is reduced with increasing temperature. Assuming the LED lamp to be five times as efficient as an incandescent lamp, it requires around 20 Watts of input power to an LED light source to produce the same light as a 100 Watt incandescent lamp. However, 16 Watts will be dissipated as heat; therefore, managing the heat of the LED lamp becomes very important.

Ideally LED junctions should be operated as close to the ambient temperature as possible, or even less than ambient if it were practical. The LED lamps that are currently beginning to appear on the market accomplish cooling by mounting the LEDs on various shaped, large aluminum heat sinks. For example, GE's model LED10P3L830/24 lamp rated at 10 Watts input power and 320 Lumens light output has a heat sink that weighs nearly ⅓ of a pound with an overall weight for the lamp of ¾ pound.

An additional issue with LEDs as a light sources is their very intense surface brightness. LEDs are now available that produce 100 Lumens from a die that is 0.05 inches by 0.05 inches or 0.0025 square inches. That is 40,000 lumens per square inch. A typical F32T8 lamp produces 2800 Lumens and has 150 square inches emitting surface or about 19 Lumens per square inch. The LED has more than 2000 times the surface brightness of a fluorescent tube. A similar problem of surface brightness occurs in the incandescent lamp; however, this problem is easily overcome by placing the incandescent filament inside a frosted envelope which diffuses the intense light from the filament over the entire surface of the glass envelope. Placing LEDs within a diffusing enclosure will help the surface intensity issue, but it creates additional problems with keeping the LEDs cool. As stated, unlike the incandescent lamp, which needs a very hot environment to create light, the LED's light output and life are both severely degraded with increasing temperature. Thus using a sealed diffused enclosure is not possible unless an efficient means can be found to keep the LEDs within the enclosure at a temperature typically on the order of 85 degrees C. or lower.

It would be advantageous to have a way of cooling a lamp or light bulb arrangement containing LED light sources without the use of heavy metal heat sinks. A method of liquid evaporative cooling would be desirable, preferably using water as a coolant.

LED cooling using evaporation of a refrigerant (or water) is taught by Rice in U.S. Published Patent Application No. 2004/0213016. Rice teaches a closed system with a heat pipe with an evaporation area proximate to the LEDs. Fluid evaporation transfers heat away from the LEDs and into hollow convection cooled fins where condensation takes place.

McCullough et al. in U.S. Pat. No. 6,976,769 teach a LED assembly having a heat pipe and a reflector body.

Budelman in U.S. Pat. No. 6,349,760 teaches a method of spraying a liquid on a heat sink.

Davis et al. in U.S. Pat. No. 6,062,302 teach a heat sink having fins with cavities along with a fluid heat transfer medium. The fluid evaporates and re-condenses in the system.

Duval in U.S. Pat. No. 6,843,308 teaches a flat sheet structured as a thermal device using a two-phase active fluid.

Miller et al. in U.S. Pat. No. 3,844,132 teach spraying the contents of a chamber under sub-atmospheric pressure to create a cooling effect.

### SUMMARY OF THE INVENTION

The present invention is directed to LED lamps that remove heat using evaporation of water or other coolant inside the glass lamp structure without the use of external heat sinks or connective fins. Generally, the pressure inside the lamp is reduced in order to lower the boiling point of the coolant. One or more LEDs is mounted on a support structure that is enclosed within a sealed enclosure such as a glass bulb attached to a base. A coolant, preferably water, or a water alcohol mixture, is contained inside the structure. When the system is cold, the coolant pools at the lowest part of the enclosure. The coolant can be wicked by various structures to the immediate vicinity of the LEDs (onto their bases, or onto the LEDs themselves). When the LEDs begin to produce heat, the coolant evaporates from them or their base surface at a relatively low temperature due to the reduced pressure. As the coolant vaporizes, it absorbs heat from the LED structure. The coolant vapor carries the heat to the outer enclosure which is initially at the surrounding ambient temperature. When the vapor contacts the cooler enclosure, it condenses and generally runs down the inside of the enclosure to the pool. The heat is conducted through the enclosure to the ambient air where it is transferred by natural convection and radiation. As the process repeats, the various surface temperatures increase due to the thermal resistance. As the vapor temperature increases, the internal pressure also increases. This in turn raises the boiling point of the coolant. The various temperatures increase until there is equilibrium between the heat generated by the LEDs and the heat transferred to the ambient environment outside the lamp enclosure. The final result is a closed heat transfer cycle where heat is picked up from the LED surfaces and transported by the vapor to the enclosure which then transfers the heat to the environment. The coolant continuously cycles between liquid and vapor. The final pressure is the vapor pressure of the coolant. As a particular coolant, water is very attractive since it absorbs 2257 Joules of energy per gram as it vaporizes (this is the latent heat of vaporization at STP—the value increases slightly when pressure is reduced), is non-toxic, and is fairly easy to handle. The non-toxicity of the coolant is very important in the consumer market where a lamp may easily be broken.

### DESCRIPTION OF THE FIGURES

Attention is now called to several illustrations that show features of the present invention:

FIG. 1 shows a vertical tube-shaped LED lamp with a wick.

FIG. 2 shows a vertical tube-shaped LED lamp with two small heat fins and no wick.

FIG. 3 shows a downward mounting vertical tube-shaped LED lamp with LEDs tilted downward.

FIG. 4A shows an embodiment of a vertical tube-shaped lamp with a top LED to eliminate shadow.

FIG. 4B shows an embodiment of a vertical tube-shaped lamp with a shortened internal stem to eliminate shadow.

FIG. 5 shows an LED lamp with a spherical bulb having LEDs mounted on a platform.

FIG. 6 shows a horizontal spherical LED lamp with a vertical wick.

FIG. 7 shows a more convention shaped lamp with the stem and wick arrangement of FIG. 1.

FIG. 8 shows a spherical LED lamp with LEDs mounted in the coolant fluid. A power supply is also shown in the base.

FIG. 9 shows a lamp similar to FIG. 8, but having a sealed LED support.

FIG. 10 shows an embodiment with a power supply in the neck of the lamp having a shape similar to the corresponding portion of a conventional lamp. The embodiment also including apertures in the support structure.

Several illustrations and drawings have been presented to aid in understanding aspects of the present invention. The scope of the present invention is not limited to what is shown in the figures.

### DETAILED DESCRIPTION OF THE INVENTION

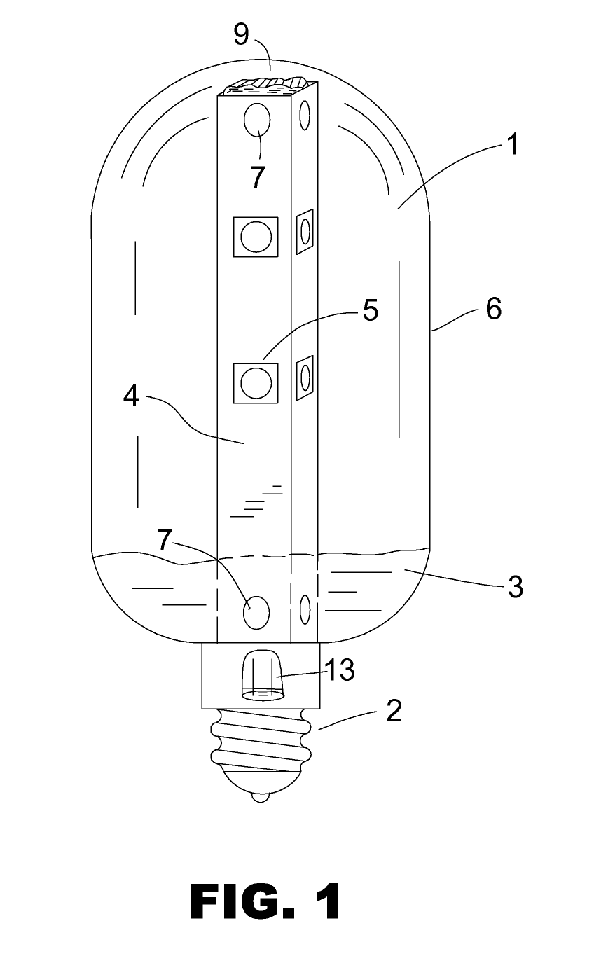

The present invention relates to LED lamps (or lamps of other types) that remove heat using evaporation of water or other coolant inside the glass lamp structure without the use of external heat sinks or connective fins. Generally, the pressure inside the lamp is reduced in order to lower the boiling point of the coolant. FIG. 1 shows an example of such a lamp.

A glass bulb 6 encloses a support structure 4 or stem that holds LEDs 5 or other light sources. This embodiment of the present invention can be operated vertically as shown in FIG. 1 or upside down. The interior of the bulb 1 can be evacuated to a pressure much lower than atmospheric pressure. A pool of coolant 3 gathers in the bottom of the enclosure. A wick 9 can wick the coolant upward past the mounted LEDs. Holes 7 in the bottom and/or top of the stem 4 allow the coolant to enter the wick 9 either in the position shown or upside down. The lamp can have a standard screw-in base 2 or any other type of base. A power supply (not shown) can convert the 120 volt line supply to DC to power the LEDs at the correct voltage and current. A position switch 13 that can be mounted in the base, such as a mercury switch known in the art, can prevent the bulb from being operated in positions that are not near vertical.

Before the lamp is powered on, the pressure inside the enclosure 1 is very low severely depressing the boiling point of the coolant 3. Upon power up, the LEDs or other light sources 5 begin to heat and immediately begin to transfer heat into the coolant fluid that is being wicked past them. When the LEDs reach the depressed boiling point of the coolant, temperature rise slows down or halts as the fluid absorbs energy to boil (based on its latent heat of vaporization). Very soon, the fluid in immediate contact with the heat source begins boiling holding the temperature at the surface near its boiling point. As the bulb interior 1 fills with vapor, the interior pressure increases according to the vapor pressure of the coolant. Soon, the vapor begins impinging on the wall of the enclosure 6 which is preferably glass. Initially, the interior surface of the bulb 6 is at ambient external temperature. This causes the vapor to immediately condense as it transfers heat to the bulb surface. The outside surface of the bulb 6 experiences natural convection with the external air and exchanges heat into the ambient air. Some heat is also transferred to the environment by radiation.

After a time, a steady state equilibrium is reached where, due to the increased pressure in the bulb over the initial evacuated state, the boiling point of the coolant has risen somewhat, and due to the conductive, radiative and convective processes at the bulb, the temperature of the bulb has risen somewhat above ambient. In steady state, the final boiling point of the coolant is low enough to maintain the LEDs within their operation ranges, and the final temperature of the inside of the bulb, while hotter than ambient, is still low enough to cause the vapor contacting it to condense. The mass movement of coolant from the pool to the LEDs; from the LEDs to the bulb as vapor; and finally back to the pool as condensation down the bulb acts as a closed system heat transfer mechanism moving heat from the LEDs to the ambient air outside the bulb.

As a particular example, assume that the coolant is water, and that the bulb is evacuated to −29.14 inches Hg Gauge. This is a 97.4% evacuation of air from the enclosure with an absolute pressure of 0.0264 atmospheres, or 2.64 kPa (0.38797 psia). Standard tables show that the boiling point of water at this pressure is around 21.92 degrees C. (say 22 degrees C.). Assume also that the ambient air exterior to the bulb (and far away) is 20 degrees C., and remains so throughout the process. When the LEDs are energized, they begin to heat, and the water in contact with their surface begins to boil. Vapor at a temperature of around 22 degrees C. fills the bulb and impinges on the inner surface of the bulb wall which initially has a temperature of around 20 degrees C. Water begins to condense on the bulb surface. However, due to the increased pressure in the bulb, the boiling point of the water increases. The final operating pressure depends entirely upon the size of the bulb, the amount of surface area evaporating fluid, the rate of heat input, the amount of surface area condensing fluid as well as its heat transfer capability. This will vary from bulb to bulb.

As an assumption for this example only, let us assume that the equilibrium bulb pressure reaches 0.25 atmospheres or 25 kPa. At this pressure, the boiling point of water is around 65 degrees C. The glass bulb is always cooler than this, but always hotter than the surrounding ambient. Generally a good first approximation is to assume that the bulb temperature is around half way between the vapor temperature and the ambient temperature or 45 degrees C. or a little hotter. We will thus assume that the outer surface of the bulb is around 37-45 degrees C., making the temperature difference around 17-25 degrees C. It is known that for curved surfaces (such as a vertical cylinder or sphere), the free convection heat flow rate is dQ/dt=h_{c} A (T_{bulb}−T_{ambient}), where h_{c} is around 1.8((T_{bulb}−T_{ambient})/D)^{0.25} empirically with D being the diameter of the bulb in meters (or other relevant linear dimension). The temperature difference is in degrees C., and the area is in sq. meters in this formula. The radiative heat transfer from the bulb surface is around Ae(T⁴_{bulb}−T⁴_{ambient})×(sigma), where A is the surface area, sigma is a universal radiation constant, e is emissivity, and temperatures in the radiation equation are in degrees K. The emissivity of glass is around 0.94. If the bulb is a sphere with a radius of 1.5 inches (3.81 cm), the surface area is 28.27 sq. in. (0.018 sq. m). Sigma is 3.657E-11 for the area given in sq. inches. The total heat transfer from this bulb to the ambient is therefore around 5-10 Watts. This assumes totally still ambient air. Any local air currents will increase convective transfer tremendously. Also, if the system is allowed to operate hotter, much more heat can be transferred. As a further example, a cylindrical bulb (with spherical top) 3.5 inches in diameter with a length of 3.5 inches can dissipate around 10-13 watts under these conditions.

LEDs with a total input of 15 Watts with an LED efficiency of 20% would result in a heat flow out of the LED of 12 Watts. It can be seen from the particular examples, the bulb system of the present invention can remove this much heat in perfectly still air (again depending upon the bulb size and shape). The final operating temperature is determined by the bulb interior surface area, the evaporative surface area and the bulb volume since that determines the final vapor pressure and hence the boiling point of the coolant. It should be noted that the examples given are to aid in understanding the present invention. These examples do not limit the scope of the present invention in any way.

In general, it is desirable to use a coolant with a boiling point at final pressure that is quite a bit less than the desired operating temperature of the LEDs. This can be accomplished using a coolant such as FREON™ that is a gas at standard conditions. However, with this coolant, the enclosure must be pressurized to force the coolant to become a liquid. Since such coolants are now rather undesirable from an environmental viewpoint, water is a better choice. Also, since the bulb with water is under a vacuum, the maximum pressure the enclosure must withstand is only 14.7 psi. In the event of a failure, the enclosure implodes rather than exploding. This permits the enclosure to be constructed less robustly.

Aqueous solutions are particularly desirable in this application in that the latent heat of vaporization is much higher than for other liquids. A possible disadvantage is that the freezing point may be higher than the ambient temperatures encountered during shipping and handling. The freezing point is virtually unaffected by evacuating the enclosure, thus water will still freeze around zero degrees C. and expand to maximum volume around four degrees C. This poses some risks for shipping since lamps may well be exposed to ambient temperatures below these in transit. This problem can be solved by careful design of the enclosure and supporting structure within the enclosure so that internal surfaces where freezing of the liquid might occur are curved, angled or constructed sufficiently strong to survive the force of the freezing coolant expanding as much as 9% (for water). Water used as a coolant normally should be distilled water since dissolved salts can raise the boiling point.

Another attractive coolant is alcohol, either in a pure state, or in a water-alcohol mixture. Pure ethyl alcohol boils at 78.5 degrees C. at standard pressure. Water-alcohol mixtures boil somewhere between the boiling point of alcohol and that of water at any given pressure depending upon the amount of alcohol in the mixture. As is well-known in the art of distilling, the first vapor that comes off is almost pure alcohol at the boiling temperature of the alcohol with more and more water coming off as the temperature rises. The latent heat of vaporization of alcohol or a water-alcohol mixture is less than that of pure water. Hence, an alcohol coolant cannot remove as much heat per gram as pure water. However, alcohol depresses the freezing point of water partially alleviating the freezing problem. Pure ethyl alcohol freezes at −114 degrees C. A preferred alcohol is ethyl alcohol or propyl alcohol (iso or straight).

The support structure that holds the LEDs provides a means for the heat generated by the LEDs to be transferred to the coolant. In some embodiments of the present invention, this structure is either a solid rod or hollow cylinder of thermally conductive material that may have an optional enlarged area at one or both ends. One or both of the ends are in contact with the liquid coolant, and heat is conducted along the structure a surface where the coolant evaporates. The efficiency of thermal conduction depends on the thermal conductivity of the material. Metals such as aluminum have very high thermal conductivities and are preferred. In other embodiments of the invention, a hollow member is used in combination with a wick. The wick can be immersed in the coolant at a lower end, and the liquid coolant is drawn up through the wick into the hollow cylinder. This allows a much larger area of the structure to be in direct contact with the liquid coolant providing a much larger evaporative surface. A simple material such as paper towel has been found to be an excellent wick material. Any wick material is within the scope of the present invention for instance strands of fiberglass or carbon fiber bundled together provide excellent wicking action and are more tolerant of higher operating temperatures. Using a porous sintered metal for the support structure combines the support function with the wicking capability. During operation, there is generally a mixture of liquid and vapor coolant present. An equilibrium is reached where heat is being continuously exchanged with the enclosure, and hence with the atmosphere through the outer surface of the enclosure.

If LEDs are used for the illumination sources, they are normally powered from a DC power source. Since the forward voltage drop of an LED is usually over 3 volts, all connections need to be well insulated to avoid the possibility of the coolant undergoing electrolysis. Also, the coolant plus any components that will be sealed within the lamp must be clean and free of any salts and contamination. This is also true for other types of light sources.

Some LEDs may be sensitive to high humidity environments. Studies carried out with the LEDs exposed to air at 85° C. and 85% humidity at normal atmospheric pressure show this effect (See. Quin et al., “Effect of temperature and moisture on the luminescence properties of silicone filled with YAG phosphor”, J. Semiconductors, January 2011,) (See Also, Tan et al., “Analysis of humidity effects on the degradation of high-power white LEDs”, Microelectronics Reliability 49 (2009) pp. 1226-1230). While these tests may not correlate directly with LEDs operating within a partial vacuum and in the absence of any significant amount of oxygen, at least certain types of LEDs may need to be protected from the coolant vapor by conformal coating or some other form of barrier to prevent the vapor from contacting the material of the LED.

Generally, the sealed enclosure is made primarily of non-opaque material which may be clear and fully transparent, translucent or colored. Translucent or frosted enclosures reduce glare due to the very intense surface light intensity of higher powered LEDs. The enclosure must be air-tight and generally capable of holding a vacuum. The inside surface of the enclosure may be coated to minimize the size of the liquid droplets condensing and provide better run-off. The surface of the enclosure may also be grooved to increase the surface area and to further diffuse the light. The sealed enclosure is typically mounted on a base which can contain a power supply and possibly a position switch that can disable the lamp if it is operated in a position where cooling would be inadequate.

Many different types of illumination sources may be used with the present invention. One type of illumination source can provide in excess of 2π steradians of illumination. Other types provide substantially omni-directional illumination.

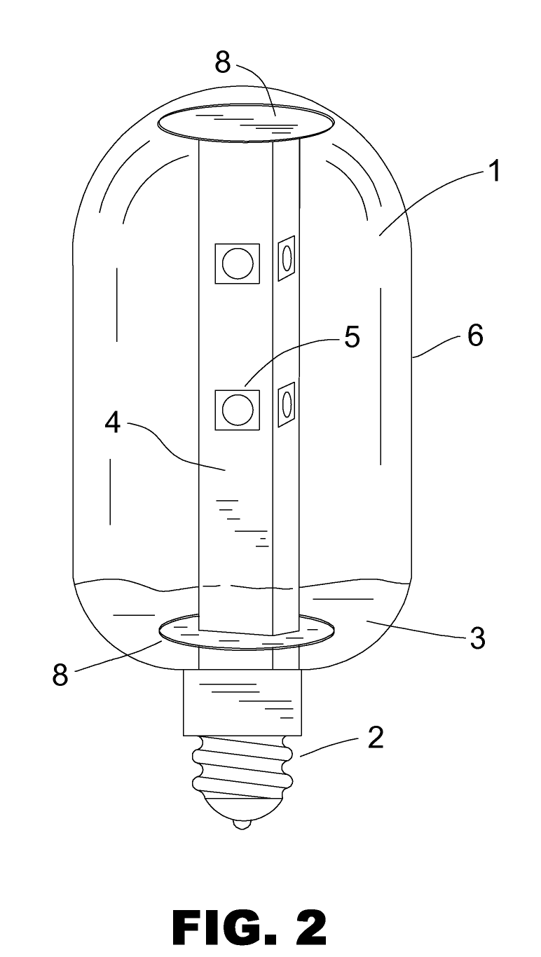

Turning to FIG. 2, an alternate embodiment of the lamp of FIG. 1 is seen. Here, no wick is used. Rather, small heat fins 8 are affixed to the top and bottom of the support structure or stem 4. Other features of this embodiment remain the same as those shown in FIG. 1. When operated in a vertical position, one of the fins is generally submerged in the coolant pool.

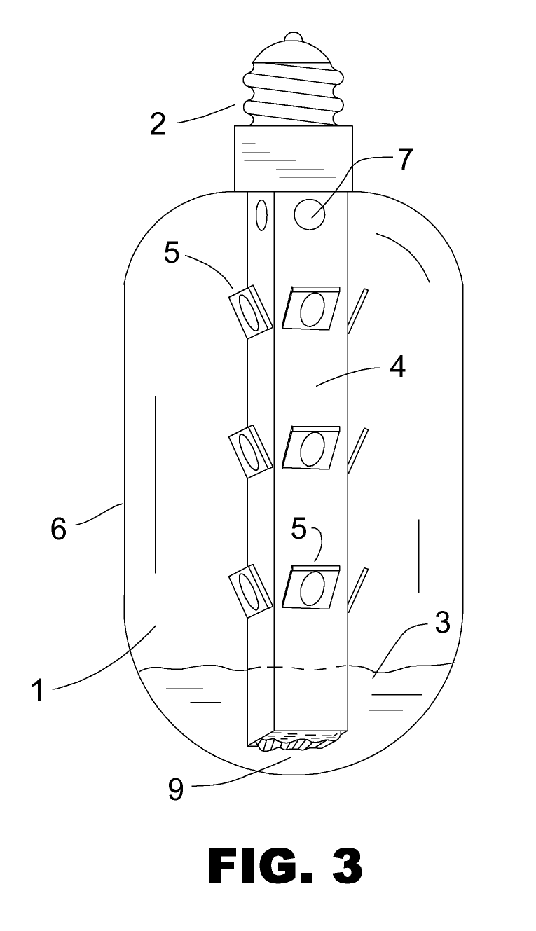

FIG. 3 shows an embodiment designed to be mounted upside down. This is similar to the embodiment of FIG. 1, but the LEDs 5 are tilted downward to project light downward. This embodiment can be used in ceiling mount applications. It can have a switch (not shown) that only allows it to operate in an upside down position.

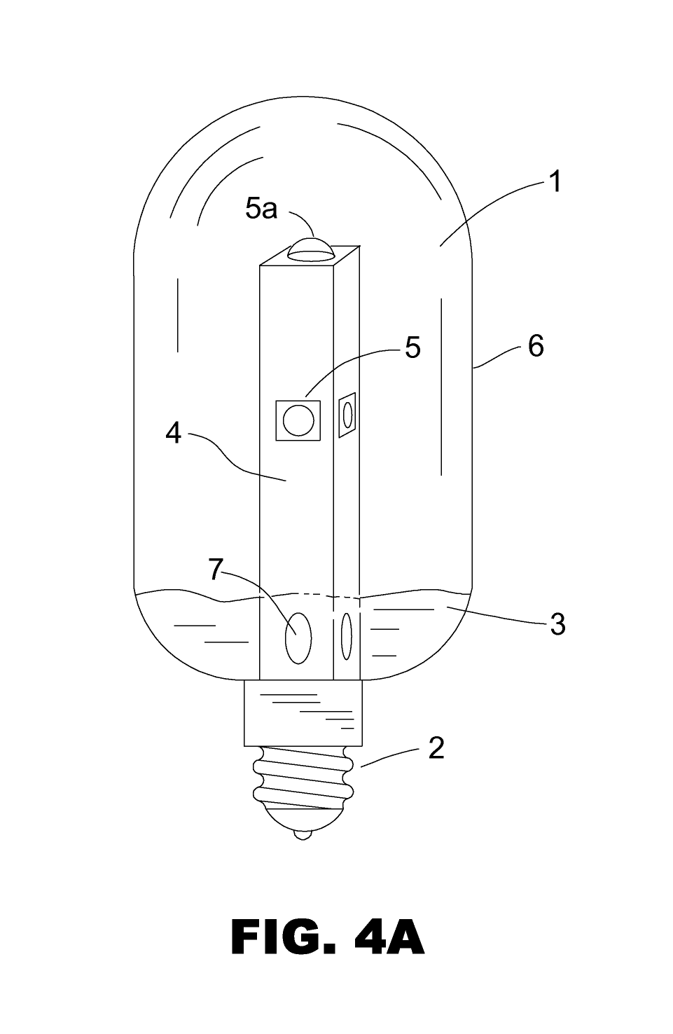

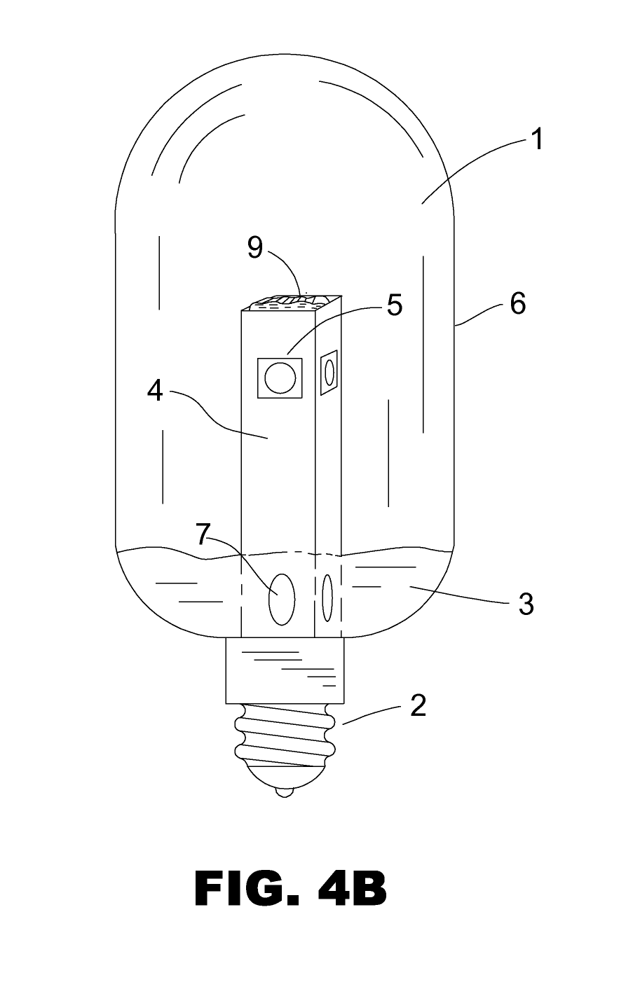

A problem with LED lamps is that there may be a shadow or dark area around the top of the lamp. FIG. 4A shows an embodiment of the invention with an LED 5a mounted on top of the support structure 4 to alleviate this problem. In FIG. 4B, a different way of solving this problem is shown, namely by making the support structure 4 shorter.

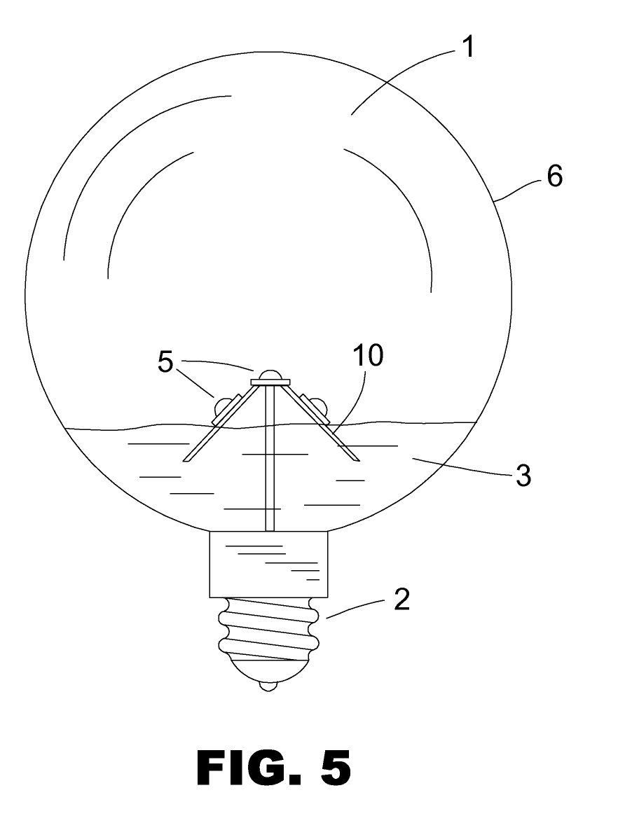

FIG. 5 shows a spherical enclosure with LEDs 5 mounted on a raised support 10 which conducts heat into the liquid pool 3. This type of support structure 10 will also work with the non-spherical bulbs previously described.

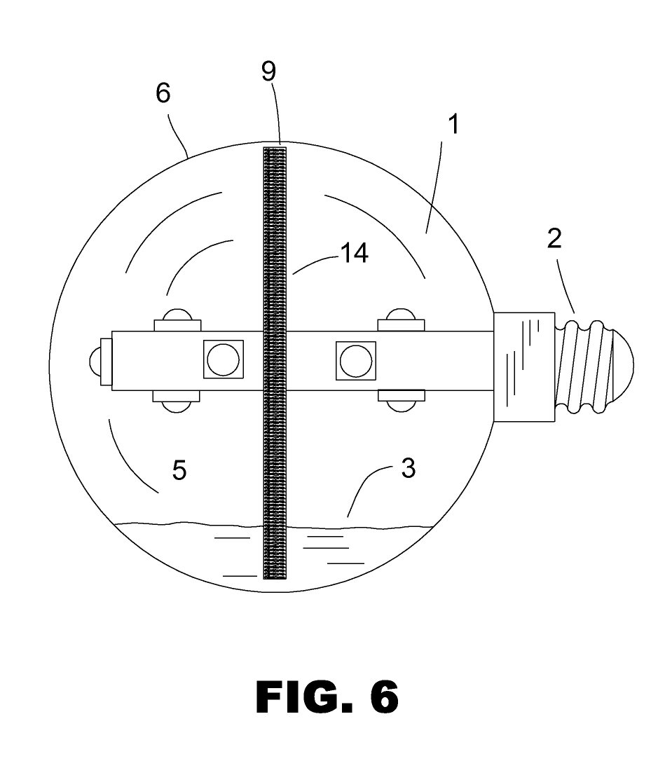

FIG. 6 shows a horizontally mounted embodiment that contains a vertical disk 14 with an optional wick 9 about its circumference. The vertical disk 14 makes sufficient contact with the coolant in any horizontal position. The disk 14 with the wick 9 allows the lamp to be screwed or turned to any angle about the horizontal axis while still touching the coolant. A switch (not shown) can disable the lamp if it is turned to a position other than horizontal.

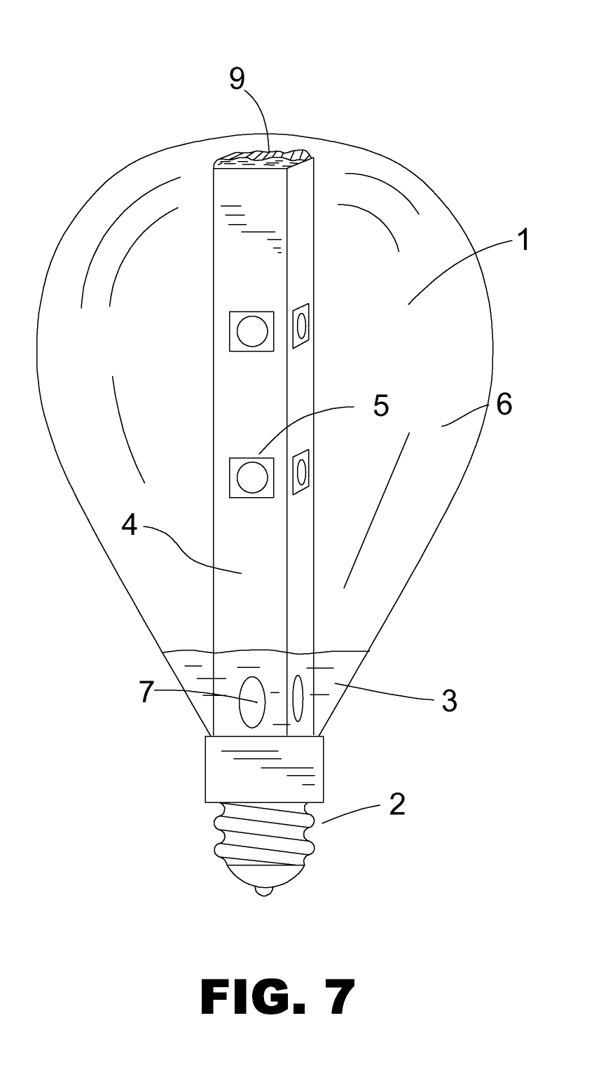

FIG. 7 shows an alternate embodiment with an internal structure similar to that of FIG. 1, but with a more conventionally shaped bulb 6.

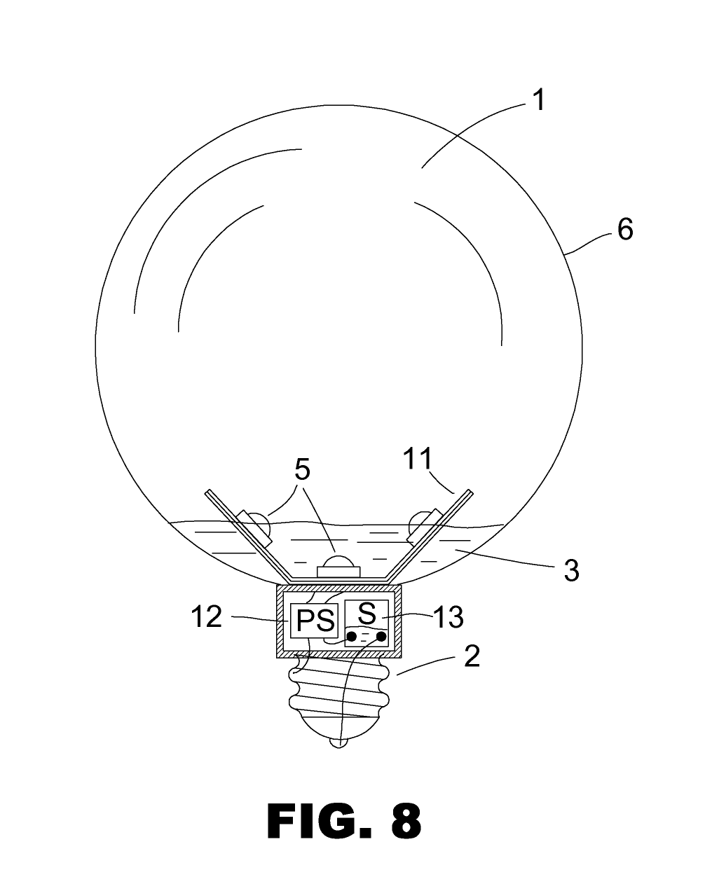

FIG. 8 shows a spherical embodiment with the LEDs 5 in contact with the coolant fluid 3. In addition, a power supply 12 is shown in the base along with a position switch 13. This can be a mercury switch or any other switch that can sense the position of the lamp as previously described. This switch 13 can disable the lamp if it is mounted in a position where cooling would be insufficient. Any electrical connections to the source of illumination must be adequately insulated sufficiently to avoid electrolysis of liquid coolant.

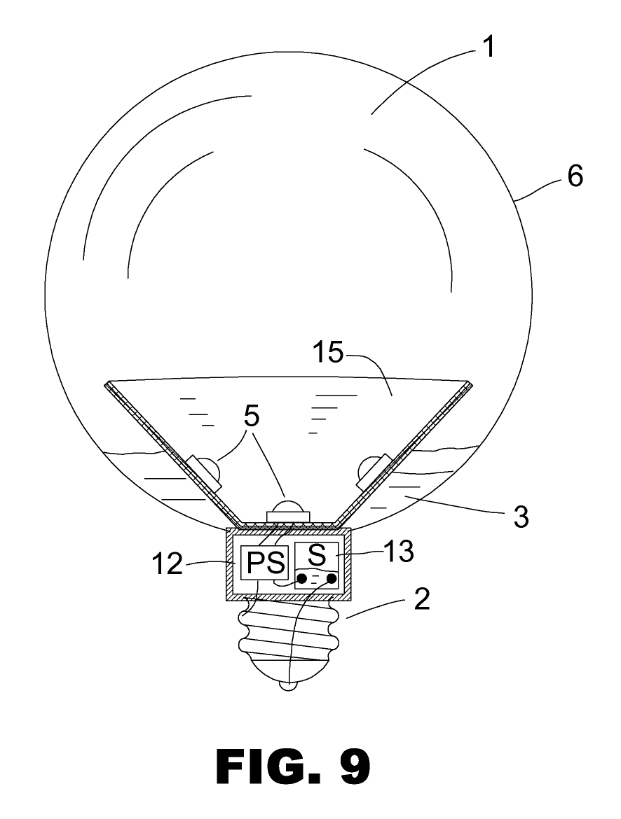

FIG. 9 shows an embodiment similar to that of FIG. 8. A spherical bulb with the LEDs 5 mounted on a thermally conductive support structure 15 which has sealed edges and prevents coolant 3 from making contact with the inside surface of the structure once the coolant has vaporized after the initial powering of the lamp.

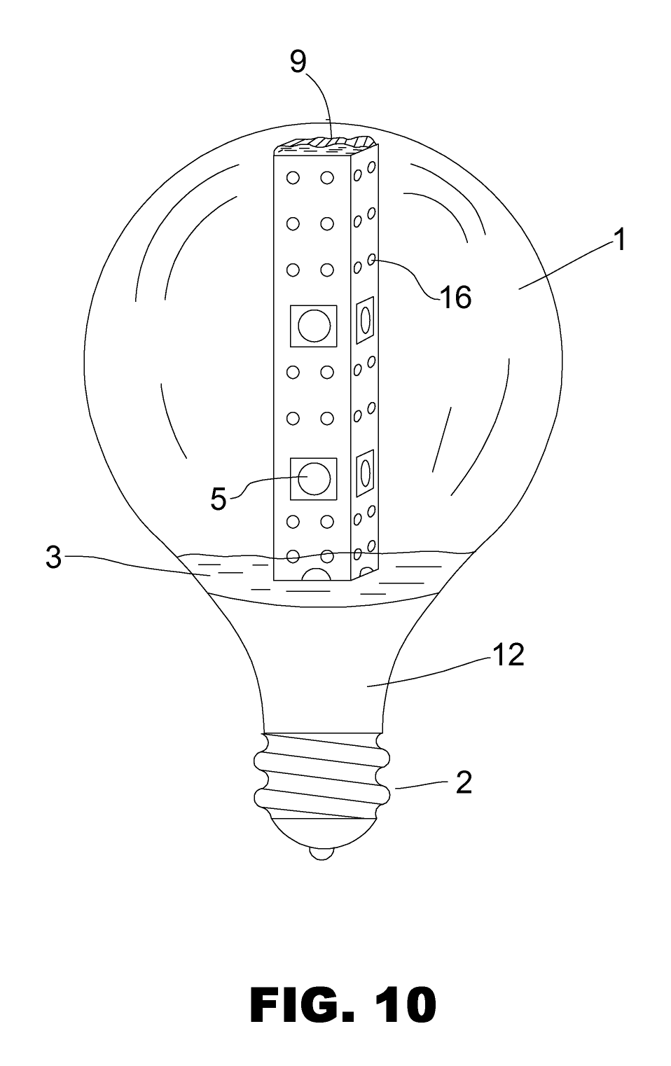

FIG. 10 shows an embodiment that has the shape of a conventional A19 or A21 incandescent lamp. The power supply is built into the base of the lamp and follows the same shape as the corresponding portion of a conventional lamp. The support structure also includes apertures 16 to facilitate the movement of the vapor from within the support structure.

It should be noted that any of the embodiments presented can, and usually will, contain power supplies, and that any of them may also contain position sensing switches to disable the lamp in a wrong position (a position where the coolant will not sufficiently cool the light producing element).

While water and alcohol have been discussed as coolants, it should be recognized that many different substances can be used for as coolants as long as the coolant boiling point at the operating pressure within the lamp is less than the maximum desired operating temperature of the illumination source by enough to cool the illumination source to a desired operating temperature.

Also, while various glasses are a preferred material for enclosures, any non-opaque material may be uses as long as it can withstand the operating temperatures of the system. It is desirable for the enclosure material to be thin enough to efficiently transfer heat to the ambient.

In alternate embodiments of the invention, the lamp may be provided with no internal power supply. In these cases, and external supply mounted somewhere in an external supporting structure may supply power to one or more lamps. This is advantageous in applications where a larger number of lamps light a single space. Here it is possibly more efficient to provide a single power supply for a number of lamps. While the figures show lamps with an Edison base, lamps powered from an external source would use another type of base which could not be screwed into an Edison type of AC socket. Any type of base, connector or insert is within the scope of the present invention.

Several descriptions and illustrations have been presented to aid in understanding the features of the present invention. One skilled in the art will realize that numerous changes and variations are possible without departing from the spirit of the invention. Each of these changes or variations is within the scope of the present invention.

We claim:

1. A lamp comprising:
an illumination source in a sealed non-opaque container, the non-opaque container also containing a coolant vapor, wherein said coolant vapor provides a thermal path between the illumination source and the inner surface of the sealed non-opaque container.

2. The lamp of claim 1 wherein said non-opaque container terminates in a base, said base containing a power supply.

3. The lamp of claim 2 wherein said base also contains a position switch, said position switch allowing said lamp to operate in a first predetermined position and preventing said lamp from operating in a second predetermined position.

4. The lamp of claim 1 wherein the coolant vapor is a alcohol or an alcohol/water mixture.

5. The lamp of claim 1 wherein said non-opaque container is glass.

6. The lamp of claim 5 wherein said glass is frosted or translucent.

7. The lamp of claim 1 wherein said non-opaque container also contains a predetermined amount of said coolant in liquid state.

8. The lamp of claim 1 wherein at or below an ambient temperature of 68 degrees Fahrenheit, the pressure within the sealed non-opaque container is less than ambient atmospheric pressure.

9. A lamp comprising:
at least one illumination source mounted on a thermally conductive support structure, the support structure mounted in a sealed, non-opaque container;
the sealed non-opaque container also containing a coolant vapor, the coolant vapor providing a thermal path between the support structure and the inner surface of the sealed non-opaque container.

10. The lamp of claim 9 wherein said sealed non-opaque container also contains coolant in liquid state.

11. The lamp of claim 9 wherein said support structure contains a wick.

12. The lamp of claim 11 wherein the majority of coolant in liquid state is contained in said wick.

13. The lamp of claim 11 wherein the length of the wick is sufficient to make contact with liquid coolant while in a base-up or base down orientation.

14. The lamp of claim 11 wherein said wick is cellulose based.

15. The lamp of claim 9 wherein the support include at least one aperture for the passage of coolant vapor.

16. The lamp of claim 9 wherein said sealed non-opaque container terminates in a base, said base also containing a position switch, wherein said position switch allows the lamp to operate in a first predetermined position, and prevents the lamp from operating in a second predetermined position.

17. The lamp of claim 9 wherein said sealed non-opaque container terminates in a base, said base containing a position switch, wherein said position switch allows the lamp to operate in a first and second predetermined position, and prevents the lamp from operating in a third predetermined position.

18. The lamp of claim 17 wherein the first predetermined position has an angular range including vertical plus and minus a predetermined number of degrees off of vertical.

19. The lamp of claim 9 wherein the sealed non-opaque container has the approximate shape and approximate size of a standard incandescent light bulb.

20. The lamp of claim 9 wherein the support structure is hollow.

21. The lamp of claim 9 wherein the length of the support structure is sufficient to make contact with liquid coolant while in a base-up or base down orientation.

22. The lamp of claim 9 wherein the support structure includes a cylinder.

23. The lamp of claim 22 wherein said cylinder is hollow.

24. The lamp of claim 22 wherein said cylinder is not a right circular cylinder, and is made up of three or more substantially flat surfaces.

25. The lamp of claim 9 wherein said sealed non-opaque container has an internal pressure less than atmospheric pressure when no power is applied to the illumination source.

26. The lamp of claim 9 wherein said illumination source is a light emitting diode.

27. The lamp of claim 9 wherein said support structure provides angled mounting of illumination sources to direct the light in a preferred direction.

28. The lamp of claim 9 wherein pressure within said sealed non-opaque container is lower than ambient atmospheric pressure.

29. The lamp of claim 9 wherein said coolant vapor is at least in part water.

30. The lamp of claim 9 wherein said coolant is at least in part alcohol.

31. The lamp of claim 9 wherein said coolant is at least in part a mixture of alcohol and water.

32. The lamp of claim 9 wherein said at least one illumination source provides in excess of 2π steradians of illumination.

33. The lamp of claim 9 wherein said at least one illumination source provides substantially omni-directional illumination.

34. The lamp of claim 9 wherein said support structure forms a sealed cup with an outside surface and wherein said sealed cup contacts the coolant on said outside surface.

35. The lamp of claim 9 wherein the lamp has a longitudinal axis, and the lamp is capable of being operated with the longitudinal axis installed horizontally.

36. The lamp of claim 9 wherein the said support structure contains a porous material capable of both supporting the illumination source and providing wicking.

37. The lamp of claim 11 wherein the wick is includes fiberglass.

38. The lamp of claim 11 wherein the wick is includes carbon fiber.

39. The lamp of claim 10 wherein said lamp includes electrical connections to the source of illumination, the electrical connections being insulated sufficiently to avoid electrolysis of liquid coolant.

40. The lamp of claim 10 wherein said illumination source is sealed from contact with liquid coolant.

41. An electric lamp having a transparent or translucent enclosure comprising:
(a) an outer surface exposed to ambient air;
(b) an inner surface enclosing an illumination source and a liquid in thermal contact with the illumination source, the illumination source causing part of the liquid to vaporize removing heat generated by the illumination source, thereby cooling the illumination source.

42. The electric lamp of claim 41 additionally comprising a base adapted to be inserted into and held by a lamp socket.

43. The electric lamp of claim 41, wherein said inner surface is isolated from the ambient air, and is subjected to a pressure different from that of the ambient air.

44. An LED enclosed by a transparent or translucent enclosure, the enclosure having:
(a) an outer surface exposed to ambient air;
(b) an inner surface enclosing the LED as well as a liquid in thermal contact with the LED, the LED causing part of the liquid to vaporize removing heat generated by the LED.

45. The LED of claim 44 wherein temperature of the inner surface is lower than that of the LED, and wherein at least part of the vaporized liquid re-liquefies by exposure to said inner surface.

46. The LED of claim 44 wherein re-liquefied liquid returns to a pool of liquid.

47. An electric lamp enclosed by a transparent or translucent enclosure comprising:
(a) an outer surface exposed to ambient air;
(b) an inner surface enclosing an illumination source as well as a liquid in thermal contact with the illumination source, and wherein the illumination source includes a plurality of LEDs mounted on a support structure, said LEDs disposed above a pool of liquid; the support structure containing a wick, part of which is immersed in said pool of liquid.

48. The electric lamp of claim 47 wherein said support structure is a cylinder.

49. The electric lamp of claim 47 further comprising a pair of terminals adapted to connect with the electric lamp and deliver electric current thereto.

50. A lamp comprising a sealed light-transmitting enclosure, said enclosure containing at least one light source and a liquid coolant that removes heat from the light source by evaporating in response to heat from the light source and re-condensing on the enclosure thus transferring heat from the light source to the enclosure.

51. The lamp of claim 50 wherein said light source is at least one LED.

52. An LED lamp comprising:
a light-transmitting enclosure evacuated to a pressure below atmospheric pressure;
a coolant collecting area in said enclosure containing a predetermined quantity of liquid coolant;
a thermally conductive LED support structure in liquid communication with said coolant, said support structure supporting at least one LED;
a fluid return path on an inner surface of said enclosure that returns condensed liquid coolant to said coolant collecting area;
whereby, said liquid coolant evaporates on a portion of said LED support structure cooling said LED.

53. The LED lamp of claim 52 wherein said coolant is a water-alcohol mixture.

54. The LED lamp of claim 52 wherein said thermally conductive LED support structure further contains a wick.

55. The LED lamp of claim 52 wherein said enclosure terminates in a base, said base containing a power supply.

56. The LED lamp of claim 52 wherein said enclosure terminates in a base, said base containing a position switch, wherein said position switch allows said lamp to operate in a first set of predetermined positions and prevents said lamp from operating in a second set of predetermined positions.

57. The LED lamp of claim 52 wherein said light-transmitting enclosure is glass.

58. The LED lamp of claim 57 wherein said glass is frosted.
